(19) United States
(12) Patent Application Publication
(10) Pub. No.: US 2015/0201559 A1
(43) Pub. Date: Jul. 23, 2015

(54) Power Mower / Weed-Lawn Edger Combo

(71) Applicants: Dennis J. Gesker, Philadelphia, PA (US); Bruce Packer, Philadelphia, PA (US)

(72) Inventors: Dennis J. Gesker, Philadelphia, PA (US); Bruce Packer, Philadelphia, PA (US)

(21) Appl. No.: 14/158,828

(22) Filed: Jan. 19, 2014

(51) Int. Cl. A01D 43/16; A01D 34/835; A01D 43/00

(52) U.S. Cl. CPC A01D 43/16; A01D 43/00; A01D 34/835

(57) ABSTRACT

The working invention featuring power lawn mower augmented with a core assembly of a rotating disk, a contact wheel and pulley wheels offers a grass cutting operator the option of simultaneously edging or weed whacking while at all times refining the actual grass clippings in service to our environment.

The invention is noteworthy by the absence of the plethora of mechanical and electrical devices necessitated by prior art.

### CROSS REFERENCE TO RELATED APPLICATION

This application claims the benefit of the U.S. Provisional Application No. 61/960.116 Filed on Sep. 10, 2013 the disclosure of which is incorporated herein by reference.

### BACKGROUND OF THE INVENTION WITH BRIEF DISCUSSION OF PRIOR ART

This working invention integrates the power grass mower with the function to edge the lawn and weed whack at the operator's option.

This working invention enhances the grass cutting experience by redirecting grass clippings into the mowers rotary blade, affording finer grass residues.

This working invention is unique for what it does not require. The usual miscellany of electrical inputs or gears, coils, springs, rods with grooves or sliding catches or dogs in general and are not requisites of this invention's core concept and application.

See and distinguish contra the below studies in complexities:

U.S. Pat. No. 3,871,160—COMBINATION LAWN MOWER AND EDGER Pub. Date. Mar. 18, 1975. (The apparatus inter-alia requires and/or incorporates a guide clamp mounted on a handle while a longitudinal rod is passing through a clamp for longitudinal movement with respect thereto and is connected to an adjustment bracket at one longitudinal end of a rod for positioning a bracket relative to a holder. A rod is required with a plurality of grooves or dogs arranged for selectively engaging with a brace forming a part of the handle and an adjustable retaining rod with respect to the handle.)

Patent 20130219845 LAWN CARE MAINTENANCE APPARATUS Pub. Date. Aug. 29, 2013. (The apparatus is essentially a mower drive wheel incorporating an edging plate including a number of different blade edge profiles for assisting in edging various types and thicknesses of grass or turf.)

Patent 20100223897 VEHICLE MOUNTED EDGE TRIMMER Pub. Date. Sep. 9, 2010. (Find here a lawn mower mounted trimmer apparatus with a trimmer head and an arm connecting the trimmer head to a mower or other vehicle.)

Patent 20050044834 LAWNMOWER AND TRIMMER Pub. Date. Mar. 3, 2005. (The apparatus inter-alia must avail itself of a battery operated trimmer motor, which is controlled by an electric switch on the handle of the lawnmower; Or alternatively, a bearing and a shaft extending below the deck upon which the trimmer cutting head is mounted, the trimmer shaft being driven by a belt drive mechanism extending between the lawnmower power shaft and the trimmer shaft.)

Patent 20040154277 TRIMMER AND EDGER ATTACHMENT FOR RIDING MOWERS Pub. Date. Aug. 12, 2004. (The apparatus inter-alia designed for riding mowers requires a trim head which is powered from a mechanism with a drive belt off of the main shaft of the mower motor. The power of the pneumatic cylinders that operate the up and down motion of the apparatus's arms comes from a twelve-volt dc motor and pump combination.)

Patent 20030230065 CLUTCH ENGAGABLE IN-LINE, LAWN TRIMMER ATTACHMENT Pub. Date: Dec. 18, 2003. (The Apparatus inter-alia requires a drive sprocket mounted on the lawn mower's cutting blade shaft.)

Patent 0111865 Al STARTER SYSTEM FOR AN ENGINE Pub. Date: May 9, 2013. (This apparatus inter-alia includes a switch actuated to turn on an electrical motor in response to the signal to start the engine.)

Patent 20030093983 MANEUVERABLE AND ADJUSTABLE LAWN MOWER HAVING AN EDGER-TRIMMING UNIT, Pub. Date: May 22, 2003. (The apparatus inter-alia requires selective engagement to an engine shaft by a clutch type mechanism, foreign to the herein submitted application.)

Patent 20020032966 TRANSMISSION FOR TRIMMER/MOWER, Pub. Date: Mar. 21, 2002. (The apparatus transmission requires a worm gear drive assembly connected to the drive shaft foreign to the herein submitted application.

U.S. Pat. No. 3,192,693 TRIMMER ATTACHMENT FOR POWER LAWN MOWER Pub. Date Jul. 6, 1965. (The apparatus inter-alia requires a motor or blade shaft having a pulley applied thereto above the internal combustion engine or power plant and a belt entrained over this pulley and over a further pulley and further engaging further mechanical operations pursuant to edging duties.)

Other Patents belonging roughly to POWER MOWER/WEED-LAWN EDGER COMBO genre share the ingenuous complexities with the above-cited patents. Considered in these further regards were: U.S. Pat. No. 2,529,870 ROTATING DISK POWER LAWN MOWER Pub. Date. Nov. 4, 1950; U.S. Pat. No. 3,192,693 TRIMMER ATTACHMENT FOR POWER LAWN MOWER Pub. Date: Jul. 6, 1965; U.S. Pat. No. 2,521,033 LAWN MOWER EDGER ATTACHMENT Pub. Date: Sep. 5, 1950; & U.S. Pat. No. 3,490,213 LAWN EDGER AND TRIMMER ADJUSTMENT APPARATUS, Pub. Date: Jan. 20, 1970.

### BRIEF SUMMARY OF THE INVENTION

This working invention grants the ability to an operator of a power lawn mower the simultaneous options to lawn edge or weed whack his lawn or garden simultaneously while cutting grass.

Owns the ability, inherent in its design, to recycle grass cuttings into the power mower blades refining the grass cutting output by virtue of the air turbulence generated within the power mowers housing.

For the virtues stated above the working POWER/WEED-LAWN EDGER COMBO has earned the popular moniker ‘Turbo-Combo Mower’.

### BRIEF DESCRIPTION OF THE DRAWINGS OF THE INVENTION

FIG. 1 is a perspective view of the invention, which partly displays a schematic view of the rotational disk and pulley system assembly housed inside the body, according to one embodiment.

FIG. 2 is an exploded schematic view of the rotational disk and pulley system assembly, according to one embodiment.

FIG. 3 is a schematic view of the rotational disk and pulley system assembly, according to one embodiment.

FIG. 4 is a perspective view of the invention, which partly displays a schematic view of the rotational disk and edge trimming blade assembly housed inside the body, according to one embodiment.

FIG. 5 is an elevated perspective view of the body with the internal pulley system exposed, according to one embodiment.

FIG. 6 is a bottom view of the invention with a schematic view of the rotational disk and pulley system assembly, according to one embodiment.

FIG. 7 is a lateral view of the rotational disk and pulley system assembly, according to one embodiment.

FIG. 8 is a perspective view of the rotational disk, according to one embodiment.

FIG. 9 is a bottom view of the rotational disk and grass cutting blade assembly, according to one embodiment.

FIG. 10 is a lateral view of the rotational disk and grass cutting blade assembly, according to one embodiment.

### DETAILED DESCRIPTION OF THE INVENTION

The below detailed description by written word and reference to drawings illustrating the embodiments of the invention claimed should not be constricted to the methodology of explanation. The terminology chosen for the purpose of description and naming parts are offered in their broadest terms with the expectations of not suffering the labor of limiting interpretations.

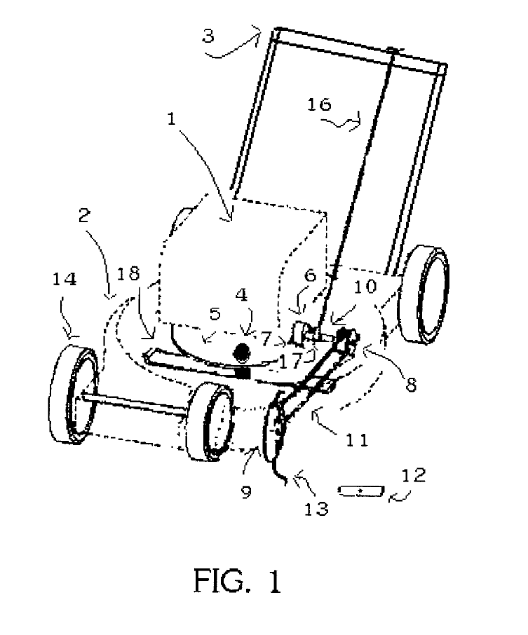

Fundamental to this invention is the utilization of a standard operating power lawn mower. It is of no moment whether or not the power lawn mower as referenced in this description is a ride-on or walk along variety or whether the power mower features an electrical or combustion engine. The working invention only requires that a power lawn mower employ a horizontally rotating Grass Cutting Blade 18 depicted in FIGS. 1-3, & 6-7, which rotates about a vertical axis be considered for the design, application, and purpose of this invention.

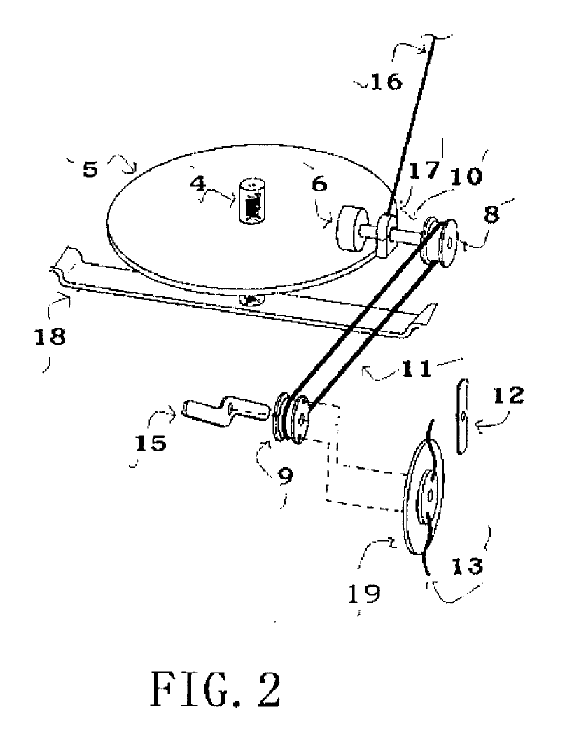

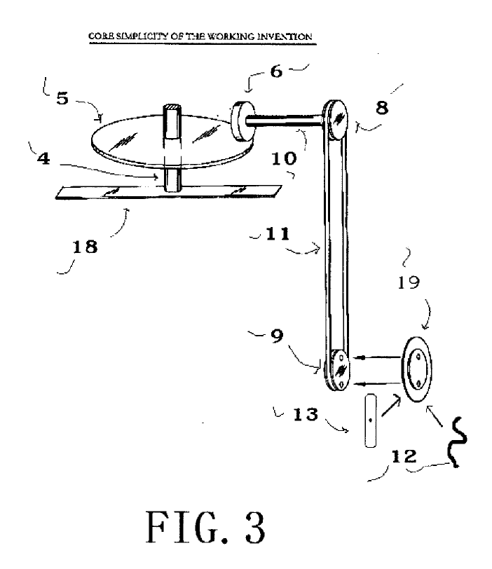

Essential to the understanding of this invention is the appreciation of the mechanical simplicity of the design as depicted by FIGS. 2-3.

Under the power mower's Frame 2, rotates a power mower's horizontally Grass Cutting Blade 18, affixed to the power mower's Drive Shaft 4. Reference FIGS. 1-4 & 6-7. To this well established power mower mechanical setting the inventor adds, collars and affixes a disk to the power mower Drive Shaft 4 resulting in a Horizontally Rotating Disk 5. Reference FIGS. 1-4 & 6-7.

The Horizontally Rotating Disk 5 is at all times placed above the power mower's grass Cutting Blade 18, and near the top of the interior of the power mower Frame 2. Reference FIGS. 1 & 6-7.

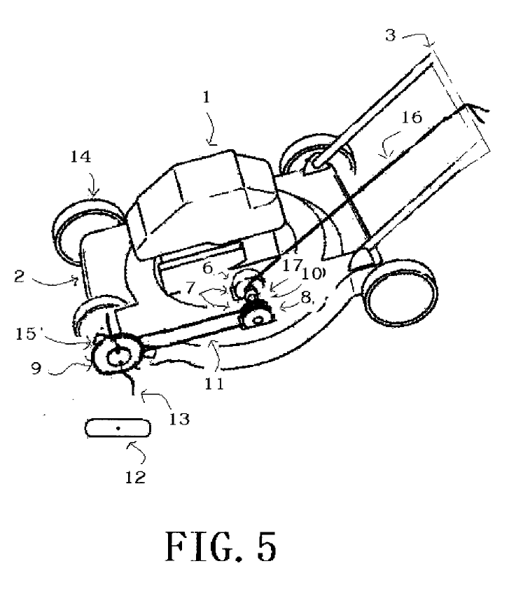

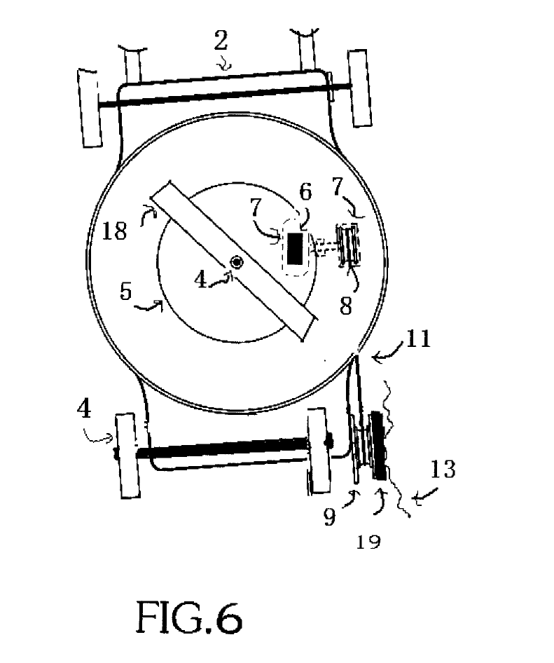

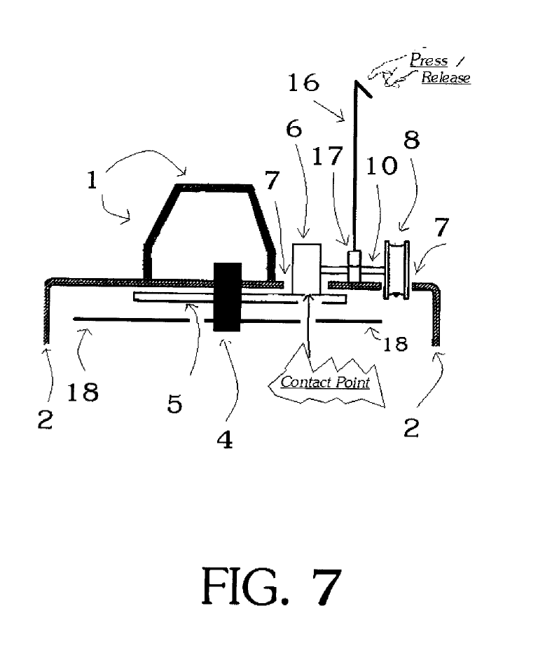

An Aperture 7, referenced in FIGS. 5-7, is notched into the top of the power mower Frame 2, for the placing of a Direct Contact Wheel 6, referenced in FIGS. 5-7, in a position to make frictional contact with the Horizontally Rotating Disk 5, inside the power mower Frame 2. In this manner, the Direct Contact Wheel 6 acquires vertical rotational movement. Reference FIG. 7.

The Direct Contact Wheel 6, gains contact with the Horizontally Rotating Disk 5, via a Pressing-Un-pressing Device 17, (of any generic manner,) reference FIG. 7, which is affixed to an Axle 10, reference FIG. 2, to be operated manually or by use of a Bowden like Cable 16, Reference FIG. 7 causing the Direct Contact Wheel 6 to gain frictional/kinetic energy and a rotational spin, reference FIG. 7, from the Horizontally Rotating Disk 5.

The Direct Contact Wheel's 6 center bore situates above the power mower Frame 2 and accommodates an Axel 10, effecting a direct connection with the Drive-Pulley-Wheel 8. Reference FIGS. 5-7.

The Drive-Pulley-Wheel 8 is situated partially in its own Aperture 7 in the power mower Frame 2 at a no-contact distant from Horizontally Rotating Disk 5 or optionally above the power mower Frame 2. The essence here is that the Drive Pulley-Wheel 8 obtains vertical rotational power by virtue of the Axel's 10 connection with the rotating Direct Contact Wheel 6. Reference FIGS. 1-2 & 5-7.

The vertically rotating Drive-Pulley-Wheel 8 in turn vertically rotates the Working-Pulley/Wheel 9 by virtue of Drive Belt 11 or a suitable band, chain, ‘o’ ring, etc. Reference FIGS. 1-3 & 5-6.

The Working-Pulley/Wheel 9 is situated toward the front, and aside the periphery of the power mower's Frame 2. Reference FIGS. 1 & 6.

Working-Pulley/Wheel 9 is designed to accept and otherwise spin and implement desired gardening tools including but not limited to an Edging Blade 12, or a Weed Whacking Cord 13. Reference FIG. 5

An Adapter 19 may be attached to the Working-Pulley Wheel 9 to assist in this chore of spinning the Edging Blade 12, or a Weed Whacking Cord 13. Reference FIGS. 2 & 6.

The Working-Pulley/Wheel 9 is designed to fix to an adjustable Lever 15, which in turn is attached front and aside the periphery of the power mower Frame 2, supporting and being capable of adjusting the height of the Working Pulley/Wheel 9. Reference FIGS. 2 & 5.

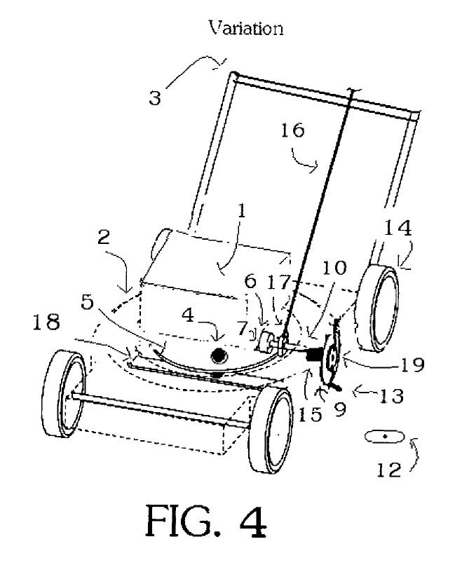

The invention includes the design variation of the eliminating the Drive Pulley Wheel 8 and having the Drive-Pulley-Wheel 9, owning the direct Axel 10 connection to the Direct Contact Wheel 6, and being placed in a position about the periphery of the power mower Frame 2. Reference FIG. 4.

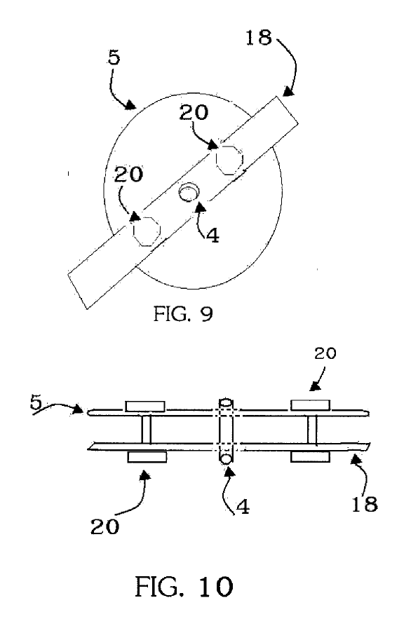

The invention includes the design variation of utilizing Connection Bolts/Struts 20 between the power mower's Grass Cutting Blade 18 and the Horizontally Rotating Disk 5, for stabilizing the rotations of the power mower's Grass Cutting Blade 18 and/or the Horizontally Rotating Disk 5, and/or to increase turbulent air flows. Reference FIG. 9 & FIG. 10.

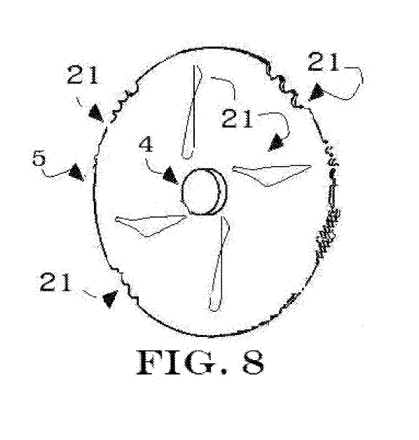

The Horizontally Rotating Disk 5 in its own right and/or in conjunction with the full assembly(s) described above, generates increased air turbulences or turbo drafts under the power mower Frame 2 that re-directs itinerant grass clippings back into the rotary power mower's Grass Cutting Blade 18, with the effect of creating finer foliage discharges. The generated turbulences are an integral quality and nature of the invention. Any number of crevices or ridges or foils, or contours, or designs placed or patterned on either side, surface, or on the rim of the Horizontally Rotating Disk 5, therefore functions fully as part of this invention. Reference FIG. 8

1-7. (canceled)

8. A power lawn mower with integrated weed whacker and edger apparatus, the apparatus comprising:
a frame having an aperture formed therein;
four wheels coupled to the frame to enable the apparatus to be moved, wherein one of the wheels is inset from an edge of the frame;
an engine;
a drive shaft;
a blade coupled to the drive shaft, wherein when the drive shaft rotates the blade is rotated horizontally in order to cut a lawn;
a disk coupled to the drive shaft above the blade, wherein when the drive shaft rotates the disk is rotated horizontally;
a contact wheel in alignment with the aperture and configured to be able to contact the disk, wherein the contact wheel is rotated vertically when in contact with the disk when it is rotating horizontally;
a drive-pulley coupled to the contact wheel;
a working-pulley coupled to the frame outside of the inset wheel and in alignment with other wheel on that side of frame; and
a drive belt coupled to the drive-pulley and the working-pulley to transfer the vertical rotation to the working-pulley, wherein the vertical rotation of the working-pulley is utilized to perform weed whacking or edging.

9. The apparatus of claim 8, further comprising an adapter coupled to the working-pulley, wherein the adapter is configured to accept gardening tools including edging blades and weed whacking chords.

10. The apparatus of claim 9, further comprising a lever coupled to the working-pulley to adjust height of the working-pulley to control the use of the gardening tools.

11. The apparatus of claim 8, further comprising a switching device to control when the contact wheel contacts the disk in order to engage/dis-engage the weed-whacking/edging functions.

12. The apparatus of claim 8, further comprising struts coupled between the blade and the disk to provide additional rotational stability.

13. The apparatus of claim 8, wherein the disk is also to direct grass clippings to be re-cut by the blade.

14. The apparatus of claim 8, wherein the drive-pulley, the working-pulley and the drive belt are located above the frame.

15. The apparatus of claim 8, further comprising an axel coupled between the contact wheel and the drive-pulley.

16. The apparatus of claim 8, wherein the disk is further to enhance air turbulence under the frame.

17. The apparatus of claim 8, wherein the weed whacking or edging is performed in alignment with edge of lawn that is being mowed at same time.

18. A power lawn mower with integrated weed whacker and edger apparatus, the apparatus comprising:
a frame having an aperture formed therein;
four wheels coupled to the frame to enable the apparatus to be moved, wherein one of the wheels is inset from an edge of the frame;
an engine;
a drive shaft;
a blade coupled to the drive shaft, wherein when the drive shaft rotates the blade is rotated horizontally in order to cut a lawn;
a disk coupled to the drive shaft above the blade, wherein when the drive shaft rotates the disk is rotated horizontally;
a contact wheel in alignment with the aperture and configured to be able to contact the disk, wherein the contact wheel is rotated vertically when in contact with the disk when it is rotating horizontally;
a drive-pulley coupled to the contact wheel;
a working-pulley coupled to the frame outside of the inset wheel in alignment with other wheel on that side of frame;
a drive belt coupled to the drive-pulley and the working-pulley to transfer the vertical rotation to the working-pulley; and
an adapter, coupled to the working-pulley, configured to accept gardening tools including edging blades and weed whacking chords, wherein the vertical rotation of the working-pulley is causes the adapter and the gardening tools to rotate and to perform weed whacking or edging tasks in alignment with edge of lawn that is being cut by the blade.

19. The apparatus of claim 18, further comprising a lever coupled to the working-pulley to adjust height of the working-pulley to control the use of the gardening tools.

20. The apparatus of claim 18, further comprising a switching device to control when the contact wheel contacts the disk in order to engage/dis-engage the weed-whacking/edging functions.

21. The apparatus of claim 18, further comprising struts coupled between the blade and the disk to provide additional rotational stability.

22. The apparatus of claim 18, wherein the disk is also to enhance air turbulence under the frame and direct grass clippings to be re-cut by the blade.

23. A power lawn mower with integrated weed whacker and edger apparatus, the apparatus comprising:
a frame having four wheels coupled thereto in order to enable the apparatus to be moved, wherein three of the wheels are coupled to an edge of the frame and a fourth wheel is inset from the edge;
an engine mounted above the frame;
a drive shaft in communication with the engine and extending below the frame;
a blade coupled to the drive shaft, wherein when the drive shaft rotates the blade is rotated horizontally in order to cut a lawn;
a disk coupled to the drive shaft above the blade, wherein when the drive shaft rotates the disk is rotated horizontally, and wherein the disk is to enhance air turbulence under the frame and direct grass clippings to be re-cut by the blade;
a contact wheel in alignment with the aperture and configured to be able to contact the disk, wherein the contact wheel is rotated vertically when in contact with the disk when it is rotating horizontally;
a switching device to control when the contact wheel contacts the disk;
a drive-pulley coupled to the contact wheel;
a working-pulley coupled to the frame outside of the inset wheel in alignment with other wheel on that side of frame;
a drive belt coupled to the drive-pulley and the working-pulley to transfer the vertical rotation to the working-pulley;
an adapter, coupled to the working-pulley, configured to accept gardening tools including edging blades and weed whacking chords, wherein the vertical rotation of the working-pulley causes the adapter and the gardening tools to rotate and to perform weed whacking or edging tasks in alignment with edge of lawn that is being cut by the blade; and
a lever coupled to the working-pulley to adjust height of the working-pulley to control the use of the gardening tools.

24. The apparatus of claim 23, further comprising struts coupled between the blade and the disk to provide additional rotational stability.
